(19) United States
(12) Patent Application Publication
(10) Pub. No.: US 2024/0380835 A1
(43) Pub. Date: Nov. 14, 2024

(54) ENHANCED ACCESSIBILITY IN BUSINESS COMMUNICATION FOR HEARING IMPAIRED INDIVIDUALS

(71) Applicant: Mezmo Corporation, Irvine, CA (US)

(72) Inventor: Haesung LEE, Irvine, CA (US)

(21) Appl. No.: 18/660,976

(22) Filed: May 10, 2024

Related U.S. Application Data
(60) Provisional application No. 63/465,489, filed on May 10, 2023.

(51) Int. Cl. H04M 1/72478; H04L 65/40; H04M 1/72466

(52) U.S. Cl. CPC H04M 1/72478; H04L 65/40; H04M 1/72466

(57) ABSTRACT

A system for enabling captioned telephone service (“CTS”) to a phone system includes a landline telephone, an adapter device, a portable electronic device for a hearing impaired user, and a CTS application installed on the portable electronic device. The landline telephone has an RJ-9 port, a 3.5 mm audio jack, a USB port, or a Bluetooth transceiver for supporting two-way communication with a headset where the landline telephone itself does not provide CTS. The adapter device includes an RJ-9 port, a 3.5 mm audio jack, a USB port, and a first Bluetooth transceiver for supporting two-way communication with the landline telephone. The adapter device further includes a second Bluetooth transceiver, a WiFi transceiver, a wired network transceiver, the adapter device being constructed to connect to the CTS application via Bluetooth connection, WiFi connection, or wired network connection.

### CROSS-REFERENCE TO RELATED APPLICATIONS

This application claims priority to U.S. provisional patent application No. 63/465,489 filed May 10, 2023, which is incorporated herein by reference in its entirety.

### FIELD OF THE INVENTION

The present invention relates to a system for enabling captioned telephone service (“CTS”) to a business phone system, and more particularly, a system for enabling CTS to a business phone system utilizing an adapter device and an electronic device equipped with a CTS application.

### BACKGROUND OF THE INVENTION

A captioned telephone service (“CTS”), also known as a transcription service, assists individuals—particularly those who are deaf or hard of hearing (“DHH”) but can speak—in making phone calls. This service, which can be provided by a human operator known as a call agent or by an automatic speech recognition (“ASR”) engine, transcribes the spoken language of a conversation partner (the “peer”) from the peer's device into caption data. This data is then sent to the user's device, displayed as text, allowing the DHH user to read what is being said in real-time.

The user's device might be any personal communications device equipped with a display such as a mobile phone, smart phone, landline, or a terminal provided by a CTS provider. The user can make or receive calls using a dedicated application, called a CTS application, installed on this device and can access transcription services facilitated by the CTS server connected to either a call agent or ASR engine.

Communication services for individuals with accessibility needs have often fallen short, particularly in business settings. While residential phones can connect to analog PSTN phone lines, business phones rely on complex communication systems with proprietary PBX call switching functionality. These systems often only support a limited number of compatible end-user phone models lacking accessibility features.

Individuals with telecommunication accessibility needs, such as the deaf or hard-of-hearing, often depend on federally-funded Telecommunication Relay Services (TRS), like Captioned Telephone Service (IPCTS) or Video Relay Services (VRS) managed by the FCC, for personal communication. Although TRS services are accessible through software applications on mobile devices or tablets, they are not compatible with business phone systems. This disconnect hinders individuals with disabilities from fully participating in business communications.

To address this gap, a novel hardware device of adapter device is proposed to leverage existing support for third-party headsets on most business phones. This adapter device would emulate a headset interface, redirecting call audio from the business phone to a separate device with enhanced accessibility capabilities.

The present invention is envisioned as a compact hardware device, akin to a USB thumb drive, capable of emulating a headset interface to provide additional accessibility features once audio handling becomes the responsibility of the adapter device. Each device is intended to have a one-to-one relationship with a specific business phone or computer.

The present invention provides several embodiments of the adapter device, each offering unique capabilities. With this invention, individuals with accessibility needs can access business phone systems and similar systems, such as video conferencing systems, without limitations.

This invention is directed to solve these problems and satisfy the long-felt need.

### SUMMARY OF THE INVENTION

The present invention contrives to solve the disadvantages of the prior art. The present invention provides a system for enabling CTS to a business phone system utilizing an adapter device and an electronic device equipped with a CTS application.

The object of the present invention is to provide a system for enabling captioned telephone service (“CTS”) to a business phone system. The system includes a telephone, an adapter device, an electronic device for a hearing impaired user, and a CTS application. The telephone has an RJ-9 port, a 3.5 mm audio jack, a USB port, or a Bluetooth transceiver for supporting two-way communication with a headset where the telephone itself does not provide CTS. The adapter device includes an RJ-9 port, a 3.5 mm audio jack, a USB port, and a first Bluetooth transceiver for supporting two-way communication with the telephone, and the CTS application is installed on the electronic device. The adapter device further includes a second Bluetooth transceiver or a WiFi transceiver, the adapter device being constructed to connect to the CTS application via Bluetooth connection or WiFi connection. The adapter device may include a codec to convert analog signals from the RJ-9 port or the 3.5 mm audio jack to digital signals and covert digital signals to analog signals for being sent to the RJ-9 port or the 3.5 mm audio jack.

Another object of the present invention is to provide an adapter device for enabling CTS to a phone system. The adapter device includes an RJ-9 port, a 3.5 mm audio jack, a USB port, and a first Bluetooth transceiver, and the adapter device further includes a second Bluetooth transceiver or a WiFi transceiver. The adapter device is constructed to connect to a telephone, which has an RJ-9 port, a 3.5 mm audio jack, a USB port, or a Bluetooth transceiver for supporting two-way communication with a headset, via the 3.5 mm audio jack, the USB port, or the first Bluetooth transceiver of the adapter device. Furthermore, the adapter device is constructed to connect to a CTS application of an electronic device for a hearing impaired user via Bluetooth connection or WiFi connection. In addition, the adapter device may include a codec to convert analog signals from the RJ-9 port or the 3.5 mm audio jack to digital signals and covert digital signals to analog signals for being sent to the RJ-9 port or the 3.5 mm audio jack.

Still another object of the present invention is to provide a system for enabling CTS to a phone system. The system includes a telephone, a video conferencing device, a first adapter device, a second adapter device, an electronic device of a hearing impaired user, and a CTS application installed on the electronic device. The telephone has an RJ-9 port, a 3.5 mm audio jack, a USB port, or a Bluetooth transceiver for supporting two-way communication with a headset where the telephone itself does not provide CTS. The video conferencing device has a first WiFi transceiver. The first adapter device includes an RJ-9 port, a 3.5 mm audio jack, a USB port, and a first Bluetooth transceiver for supporting two-way communication with the telephone, and the second adapter device includes an RJ-9 port, a 3.5 mm audio jack, a USB port, a second WiFi transceiver, and a third WiFi transceiver for supporting two-way communication with the video conferencing device.

The first adapter device further comprises a second Bluetooth transceiver and a fourth WiFi transceiver, and the first adapter device is constructed to connect to the CTS application of the electronic device via Bluetooth connection or WiFi connection. In addition, the second adapter device is constructed to connect to the CTS application of the electronic device via WiFi connection. The first and second WiFi transceivers are configured to share a same network, and the third and fourth WiFi transceivers are configured to share a same network. Furthermore, the first and third WiFi transceivers are configured not to share a same network. The first adapter device may include a codec to convert analog signals from the RJ-9 port or the 3.5 mm audio jack to digital signals and covert digital signals to analog signals for being sent to the RJ-9 port or the 3.5 mm audio jack.

The advantages of the present invention are: (1) the present invention facilitates captioned telephone service to business phone systems, which are typically not accessible to deaf or hard of hearing individuals, where the system uses an adapter device that connects the phone system to a CTS application installed on an electronic device of a hearing impaired user; (2) the present invention can be used not only with business phone systems but also with home phones and supports a wide range of communication services including audio and video conferencing through platforms like Microsoft Teams, Google Meet, Skype, and Zoom; (3) the adapter device can connect to phones via multiple interfaces such as RJ-9 ports, 3.5 mm audio jacks, USB ports, Bluetooth transceivers, and Wi-Fi, allowing the adapter device to serve as a universal link between the phone systems and various devices equipped with the CTS application; (4) the system of the present invention supports multiple users, allowing them to access and/or share a single business phone or video conferencing system (this feature is particularly beneficial in professional environments where different users may need to use the same communication infrastructure); (5) By emulating a headset, the system of the present invention offers a natural isolation layer within corporate environments, minimizing security risks associated with connecting accessibility devices to the corporate network; (6) the system of the present invention includes robust call control capabilities that can be managed through simple controls such as a one-button call control on the adapter device; (7) the adapter device can emit Bluetooth beacon messages or similar wireless signals to indicate its availability and operational status, allowing for easy discovery and connection by nearby mobile devices; and (8) the system of the present invention allows for seamless integration with existing corporate and home phone systems, reducing the need for extensive modifications or upgrades to current infrastructures.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a structure of the accessible business telephone system utilizing an adapter device according to embodiment 1 of the present invention;

FIGS. 2A, 2B, and 2C show structures and features of the accessible business telephone systems according to embodiment 1 of the present invention;

FIG. 3 shows a structure of the accessible business telephone system utilizing an adapter device and peripherals according to embodiment 2 of the present invention;

FIGS. 4 and 5 show structures of the accessible business telephone systems utilizing an adapter device and a video conferencing device according to embodiment 3 of the present invention;

FIG. 6 shows a structure of the accessible business telephone system utilizing multiple adapter devices according to embodiment 4 of the present invention;

FIG. 7 shows a feature of the accessible business telephone system according to embodiment 5 of the present invention;

FIG. 8 shows a structure of the accessible business telephone system accommodating multiple users according to embodiment 6 of the present invention; and

FIG. 9 shows network isolation layers for the accessible business telephone system according to the present invention.

### DETAILED DESCRIPTION OF EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

The present invention provides a system for enabling captioned telephone service (“CTS”) to a business phone system. The system includes a telephone 30 which has an RJ-9 port, a 3.5 mm audio jack, a USB port, or a Bluetooth transceiver for supporting two-way communication with a headset, where the telephone 30 itself does not provide CTS; a first adapter device 10 which includes an RJ-9 port, a 3.5 mm audio jack, a USB port, and a first Bluetooth transceiver for supporting two-way communication with the telephone 30; a first electronic device 20 of a first hearing impaired user; and a CTS application installed on the first electronic device 20 of the first hearing impaired user.

The telephone 30 can be either analog or digital, depending on the technology used to transmit voice signals. It may operate over the PSTN (Public Switched Telephone Network), ISDN (Integrated Services Digital Network), or utilize VOIP (Voice over Internet Protocol) technology, or it may function as part of a private branch exchange, among other options. In addition, The electronic device 20 includes any communications device equipped with a display, including but not limited to mobile phones, smart phones, tablet computing devices, laptop computers, PDAs, and terminals provided by CTS providers. The first adapter device 10 further includes a second Bluetooth transceiver, a WiFi transceiver, or a wired network transceiver. In addition, the first adapter device 10 is constructed to connect to the CTS application of the first portable electronic device 20 via Bluetooth connection, WiFi connection, or wired network connection.

The first adapter device includes a codec to convert analog signals from the RJ-9 port or the 3.5 mm audio jack to digital signals and covert digital signals to analog signals for being sent to the RJ-9 port or the 3.5 mm audio jack.

The telephone 30 may provide robust call control capabilities, and the second Bluetooth transceiver and the CTS application are configured to support the robust call control capabilities. The robust call control capabilities may include a one-button call control, where pressing a button can answer an incoming call or end an ongoing call, a double press of the button might trigger the device to redial the last number called, a long press or a specific quick press sequence on the same button may mute or unmute the microphone during a call, and/or pressing the button may activate voice commands to allow the user to control the device or make calls hands-free. In addition, the system may be configured to provide in-call audio streaming.

The system may further include a video conferencing device 40. The CTS application is configured to support video conferencing, and the first adapter device 10 is configured to connect the video conferencing device 40 and the CTS application.

In the alternative embodiment, the system may further include a video conferencing device 40 and a second adapter device 10′. The CTS application is configured to support video conferencing, and the second adapter device 10′ is configured to connect the video conferencing device 40 and the CTS application.

In still alternative embodiment, the system may further include a second portable electronic device 20′ of a second hearing impaired user. The CTS application is installed on the second portable electronic device 20 of the second hearing impaired user, and the first adapter device 10 is constructed to connect to the CTS application of the second portable electronic device 20′ via Bluetooth connection, WiFi connection, or wired network connection. Furthermore, the second Bluetooth transceiver may be configured to emit periodic Bluetooth “Beacon” messages.

In the alternative embodiment, the present invention provides an adapter device 10 for enabling CTS to a phone system. The adapter device 10 includes one or more of an RJ-9 port, a 3.5 mm audio jack, a USB port, and a first Bluetooth transceiver. The adapter device 10 further includes a second Bluetooth transceiver, a WiFi transceiver, or a wired network transceiver.

The adapter device 10 is constructed to connect to a telephone 30, which has an RJ-9 port, a 3.5 mm audio jack, a USB port, or a Bluetooth transceiver for supporting two-way communication with a headset, via the 3.5 mm audio jack, the USB port, or the first Bluetooth transceiver of the adapter device 10. The adapter device 10 is constructed to connect to a CTS application of an electronic device 20 for a hearing impaired user via Bluetooth connection, WiFi connection, or wired network connection.

In addition, the adapter device 10 includes a codec to convert analog signals from the RJ-9 port or the 3.5 mm audio jack to digital signals and covert digital signals to analog signals for being sent to the RJ-9 port or the 3.5 mm audio jack.

The telephone 30 may provide robust call control capabilities, and the second Bluetooth transceiver and the CTS application are configured to support the robust call control capabilities. The robust call control capabilities may include a one-button call control.

The adapter device 10 is configured to connect a video conferencing device 40 and another CTS application of another electronic device 20′ for another hearing impaired user, and the another CTS application is configured to support video conferencing. Furthermore, the second Bluetooth transceiver may be configured to emit periodic Bluetooth “Beacon” messages.

Still in the alternative embodiment, the present invention provides a system for enabling CTS to a phone system. The system includes a landline telephone 30 which has an RJ-9 port, a 3.5 mm audio jack, a USB port, or a Bluetooth transceiver for supporting two-way communication with a headset, where the landline telephone itself does not provide CTS; a video conferencing device 40 which has a first WiFi transceiver; a first adapter device 10 which includes an RJ-9 port, a 3.5 mm audio jack, a USB port, and a first Bluetooth transceiver for supporting two-way communication with the landline telephone 30; a second adapter device 10′ which includes an RJ-9 port, a 3.5 mm audio jack, a USB port, a second WiFi transceiver, and a third WiFi transceiver for supporting two-way communication with the video conferencing device 40; a portable electronic device 20 of a hearing impaired user; and a CTS application installed on the portable electronic device 20 of the hearing impaired user.

The first adapter device 10 further includes a second Bluetooth transceiver and a fourth WiFi transceiver, and the first adapter device 10 is constructed to connect to the CTS application of the portable electronic device 20 via Bluetooth connection or WiFi connection. Furthermore, the second adapter device 10′ is constructed to connect to the CTS application of the portable electronic device 20 via WiFi connection. The first and second WiFi transceivers are configured to share a same network, the third and fourth WiFi transceivers are configured to share a same network, and the first and third WiFi transceivers are configured not to share a same network.

The first adapter device 10 includes a codec to convert analog signals from the RJ-9 port or the 3.5 mm audio jack to digital signals and covert digital signals to analog signals for being sent to the RJ-9 port or the 3.5 mm audio jack.

The landline telephone 30 may provide robust call control capabilities, and the second Bluetooth transceiver and the CTS application may also be configured to support the robust call control capabilities. The robust call control capabilities may include a one-button call control. In addition, the system may be configured to provide in-call audio streaming.

The present invention provides a number of embodiments.

### Embodiment 1 (Adapter Device—Accessibility Via Mobile Phone/Tablet)

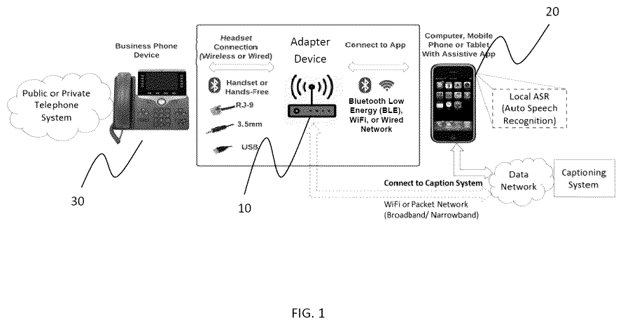

As shown in FIG. 1, the adapter device 10 establishes a headset connection with a business phone through either a wired or wireless interface. It links call control signals and audio to a mobile phone 20 or tablet 20 via a separate network connection. An accompanying app manages the audio streams for both incoming and outgoing calls and, where feasible, may exert control over the business phone.

The adapter device 10 functions as a headset for the business phone while presenting itself as a network device (such as Bluetooth Low Energy, WiFi, or wired network) to the mobile phone/tablet. It offers an API for call control and facilitates bidirectional streaming of call audio. The app treats communication with the adapter device 10 as a telephone line and can furnish accessibility services via an internet connection to a service provider.

For the headset connection, the adapter device 10 can utilize various interfaces, including analog wired (RJ-9 or 3.5 mm), digital USB, or wireless Bluetooth.

Regardless of the chosen headset connection option, the adapter device 10 assumes control of the incoming and outgoing audio streams during a phone call. Certain options additionally furnish enhanced call control and volume adjustment functionality. Further details are presented as below:

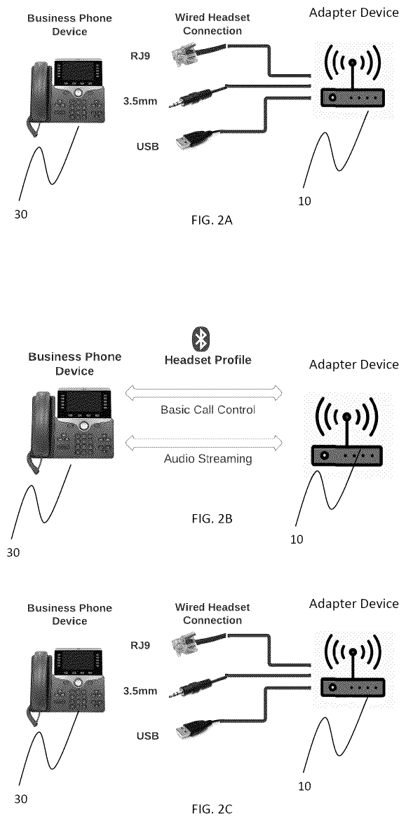

FIG. 2A illustrates Bluetooth using a Hands Free Profile (Allows robust call control capabilities; Fewer Business Phones support this profile; and In-Call Audio Streaming (optional)).

FIG. 2B illustrates Bluetooth using a Headset Profile (Very Basic “One-button” call control (i.e. hangup); More common support among business phones; and In-Call Audio Streaming).

FIG. 2C illustrates wired headset to adapter device 10 (Can be RJ9, USB, or 3.5 mm; Covers almost 100% of business phones; In-Call Audio Streaming; and Very little call control (if any)).

One of the key benefits of the adapter device 10 is its ability to enable headset call audio and first-party call control (of the business phone 30) for a software app running on various devices 20 such as mobile phones, tablets, laptops, or desktop computers. Below outlines several potential mobile phone or tablet apps that could interact with the adapter device 10 to offer accessible services to a business phone user.
Captioned Telephone Service (IP-CTS) (Deaf/HoH): An app running on the phone or tablet can direct the remote party's audio to a real-time captioning service where the captions are displayed on the mobile phone/tablet or on a secondary display.
Amplified Telephone (Deaf/HoH): An app running on a phone or tablet can amplify or otherwise process the audio to tailor the listening of the audio based on a user's audiogram or audio listening preferences.
Video Relay Services (VRS) (Deaf/HoH/Deaf Blind): An app running on the mobile phone or tablet can direct the remote party's audio to a video relay service interpreter. The app would route interpreter's voice to replace or conference in with microphone audio on the mobile phone device.
IP-Relay/Text Relay/STS (Deaf/HoH/Deaf Blind/Speech disability): An app running on the mobile phone or tablet can direct the remote party's audio to a CA or service that provides IP-Relay or Text Relay services including speech-to-speech services. All of the forms of relay, VCO, HCO, etc. can be supported via the app.
Language Translation: An app running on a mobile phone or tablet can direct the remote party's audio to a translator or translation service, where the display of the phone or tablet can provide a way to visually display the translated text.
Caller ID Announcement And High Contrast Display (Blind/Low Vision): An app running on a mobile phone or tablet can perform call control assistance by vocally announcing the incoming caller-id of a call. Additionally that information, as well as other call status and call control information may be displayed in a larger font/higher contrast display that might be available via the tablet or mobile phone. In some of these embodiments of this use case, the Business phone would remain the audio device, and the app would ONLY be providing assistance on call control functions. Additionally the app could support other speech commands via speech recognition to perform things like: Voice Dialing, Answer/Hangup/Transfer, etc. . . . via speech recognition.
Interfacing with other telephone assistive devices designed to connect to computers or mobile phones/tablets (Blind/Deaf Blind/Mobility/Cognitive, etc.): An app running on a mobile phone, tablet or computer may be able to provide accessibility accommodation through separate 3rd-party equipment as a peripheral device to the mobile phone, tablet or computer. For example, a refreshable braille display may connect to a mobile phone or computer via a bluetooth HID (Human Interface Device) connection and be able to enable a Deaf-Blind person to use a business phone system in a functionally equivalent way.

### Embodiment 2 (Adapter Device—Accessibility Via Integrated Peripherals)

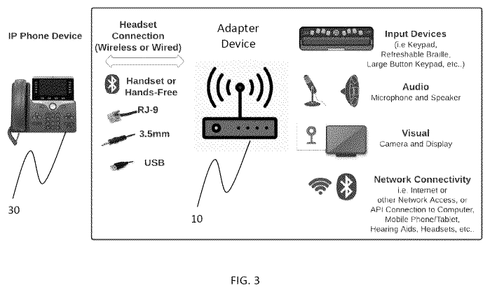

As shown in FIG. 3, the adapter device 10 is designed to connect to a business phone 30 via either a wired or wireless interface and offers assistive technology. This technology leverages a combination of integrated peripherals and network services, including internet-hosted services, apps running on computers, mobile phones, or tablets 20, and other functionalities accessible via a network interface.

This device integrates peripherals either built within a single enclosure or connected externally through wired or wireless means, such as a standard keyboard connecting via a USB port.

In this embodiment, the combination of the adapter device 10 and the peripherals is not a single entity but represents a family of devices. Each variant is tailored with specific peripherals to best accommodate different types of disabilities.

Additionally, these integrated peripherals can be used in conjunction with external devices such as computers, mobile phones, or tablets, which facilitate phone accessibility through software applications. For instance, an app providing captioning services might use the integrated microphone and speakers as primary audio sources for call participation, while using a tablet's display to show captions.

Alternatively, the combination can be purpose-built to provide accessibility independently, without needing to interface with separate software applications.

### Embodiment 3 (Adapter Device—Accessibility for a Plurality of Software-Based Video/Audio Communication Services in Addition to a Business Phone Device)

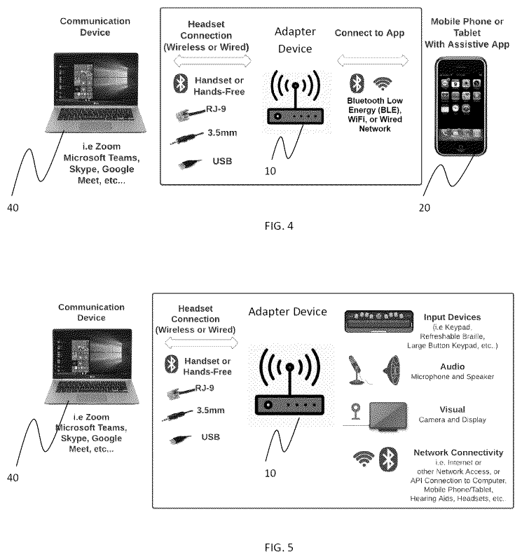

As shown in FIGS. 4-5, in addition to emulating a headset for a business phone system 30, the adapter device 10 also offers a similar solution for enhancing accessibility in various communication services. This includes Video and Audio Conferencing through software-based platforms such as Microsoft Teams™, Google Meet™, Skype™, Zoom™, and others. In these instances, the primary difference is that the adapter device interfaces with a computer, tablet, or other A/V device 40 capable of participating in a video conferencing system, rather than with a business phone 30.

### Embodiment 4 (Adapter Device—Multiple New Devices Associate to a Single Assistive App)

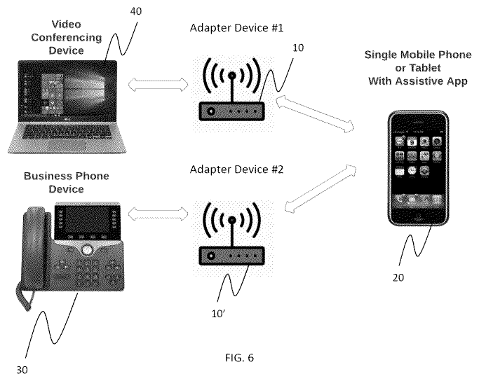

As shown in FIG. 6, this embodiment expands on earlier ones by allowing a single computer, mobile phone, or tablet 20 equipped with an assistive app to connect with multiple adapter devices 10, 10′. This setup ensures users have consistent access to familiar accessibility tools through the app, regardless of whether the telecommunications service is delivered via a business phone 30 or real-time video conferencing services 40. Additionally, users can seamlessly switch between various adapter devices 10, 10′ using controls within the app, eliminating the need for physical connections or disconnections of hardware.

### Embodiment 5

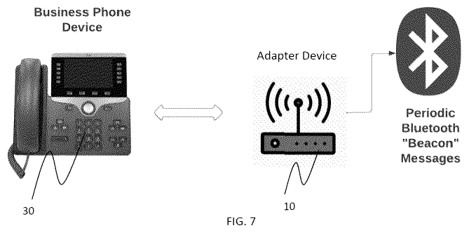

As shown in FIG. 7, in this embodiment, the adapter device 10 can indicate its operational status by sending out Bluetooth ‘beacon’ messages or similar wireless signals (e.g., mDNS over WiFi). This functionality allows a mobile app on a smartphone 20 to detect the presence and availability of the adapter device 10 simply by being within range to receive these network messages.

### Embodiment 6 (Adapter Device—Multiple Users can Make Ad-Hoc Connections to the Same Adapter Device)

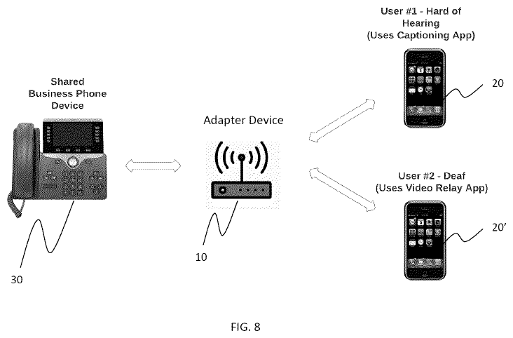

As shown in FIG. 8, in this embodiment, a single business phone device 30 or video conferencing system 40 can provide customized accessibility support to different users without prior configuration. Users can discover the adapter device 10 on an ad-hoc basis, allowing them to share access to a single business phone 30 or video conferencing system 40 and utilize accessibility features suited to their individual needs.

For example, the adapter device may signal its availability by transmitting periodic Bluetooth beacon packets, which can be detected by mobile phones 20 within close proximity.

Additionally, this embodiment allows multiple users to participate concurrently in the same business phone call using the adapter device as a conferencing bridge. Alternatively, users can connect to the adapter device 10 for separate business calls at different times.

Network Security Considerations—Accessibility Accommodation can be Isolated from Corporate Network

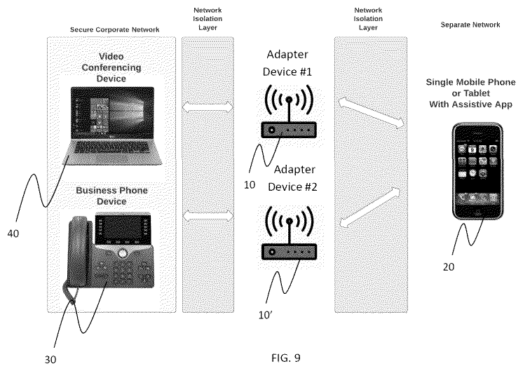

As shown in FIG. 9, one advantage of the adapter device 10 is the isolation it can provide when integrated into a corporate environment. It can be easily configured as a headset, offering accessibility within a corporate setting without necessitating additional access permissions on the corporate network.

By emulating a headset, the adapter device 10 creates an effective security barrier, allowing it to connect to the corporate network with minimal security risk.

In an alternative embodiment, the adapter device 10 may utilize Wi-Fi, incorporating all previously mentioned structures. Additionally, it can be used with landline home phones as well as business phones 30.

While the invention has been shown and described with reference to different embodiments thereof, it will be appreciated by those skilled in the art that variations in form, detail, compositions and operation may be made without departing from the spirit and scope of the invention as defined by accompanying claims.

What is claimed is:

1. A system for enabling captioned telephone service (“CTS”) to a business phone system, comprising:
a telephone which has an RJ-9 port, a 3.5 mm audio jack, a USB port, or a Bluetooth transceiver for supporting two-way communication with a headset, wherein the telephone itself does not provide CTS;
a first adapter device which includes one or more of an RJ-9 port, a 3.5 mm audio jack, a USB port, and a first Bluetooth transceiver for supporting two-way communication with the telephone;
a first electronic device of a first hearing impaired user; and
a CTS application installed on the first electronic device of the first hearing impaired user,
wherein the first adapter device further comprises a second Bluetooth transceiver, a WiFi transceiver, or a wired network transceiver, and
wherein the first adapter device is constructed to connect to the CTS application of the first electronic device via Bluetooth connection, WiFi connection, or wired network connection.

2. The system of claim 1, wherein the first adapter device includes a codec to convert analog signals from the RJ-9 port or the 3.5 mm audio jack to digital signals and covert digital signals to analog signals for being sent to the RJ-9 port or the 3.5 mm audio jack.

3. The system of claim 1, wherein the telephone provides robust call control capabilities, and the second Bluetooth transceiver and the CTS application are configured to support the robust call control capabilities.

4. The system of claim 3, wherein the robust call control capabilities include a one-button call control.

5. The system of claim 1, wherein the system is configured to provide in-call audio streaming.

6. The system of claim 1, further comprising a video conferencing device,
wherein the CTS application is configured to support video conferencing, and
wherein the first adapter device is configured to connect the video conferencing device and the CTS application.

7. The system of claim 1, further comprising a video conferencing device and a second adapter device,
wherein the CTS application is configured to support video conferencing, and
wherein the second adapter device is configured to connect the video conferencing device and the CTS application.

8. The system of claim 1, further comprising a second electronic device of a second hearing impaired user,
wherein the CTS application is installed on the second electronic device of the second hearing impaired user, and
wherein the first adapter device is constructed to connect to the CTS application of the second electronic device via Bluetooth connection, WiFi connection, or wired network connection.

9. The system of claim 1, wherein the second Bluetooth transceiver is configured to emit periodic Bluetooth “Beacon” messages.

10. An adapter device for enabling CTS to a business phone system, comprising one or more of an RJ-9 port, a 3.5 mm audio jack, a USB port, and a first Bluetooth transceiver,
wherein the adapter device further includes a second Bluetooth transceiver, a WiFi transceiver, or a wired network transceiver,
wherein the adapter device is constructed to connect to a telephone, which has an RJ-9 port, a 3.5 mm audio jack, a USB port, or a Bluetooth transceiver for supporting two-way communication with a headset, via the 3.5 mm audio jack, the USB port, or the first Bluetooth transceiver of the adapter device,
wherein the adapter device is constructed to connect to a CTS application of an electronic device for a hearing impaired user via Bluetooth connection, WiFi connection, or wired network connection.

11. The adapter device of claim 10, wherein the adapter device includes a codec to convert analog signals from the RJ-9 port or the 3.5 mm audio jack to digital signals and covert digital signals to analog signals for being sent to the RJ-9 port or the 3.5 mm audio jack.

12. The adapter device of claim 10, wherein the telephone provides robust call control capabilities, and the second Bluetooth transceiver and the CTS application are configured to support the robust call control capabilities.

13. The adapter device of claim 12, wherein the robust call control capabilities include a one-button call control.

14. The adapter device of claim 10, wherein the adapter device is configured to connect a video conferencing device and another CTS application of another electronic device for another hearing impaired user, and
wherein the another CTS application is configured to support video conferencing.

15. The adapter device of claim 10, wherein the second Bluetooth transceiver is configured to emit periodic Bluetooth “Beacon” messages.

16. A system for enabling CTS to a business phone system, comprising:
a telephone which has an RJ-9 port, a 3.5 mm audio jack, a USB port, or a Bluetooth transceiver for supporting two-way communication with a headset, wherein the telephone itself does not provide CTS;
a video conferencing device which has a first WiFi transceiver;
a first adapter device which includes an RJ-9 port, a 3.5 mm audio jack, a USB port, and a first Bluetooth transceiver for supporting two-way communication with the telephone;
a second adapter device which includes an RJ-9 port, a 3.5 mm audio jack, a USB port, a second WiFi transceiver, and a third WiFi transceiver for supporting two-way communication with the video conferencing device;
an electronic device of a hearing impaired user; and
a CTS application installed on the electronic device of the hearing impaired user,
wherein the first adapter device further comprises a second Bluetooth transceiver and a fourth WiFi transceiver,
wherein the first adapter device is constructed to connect to the CTS application of the electronic device via Bluetooth connection or WiFi connection,
wherein the second adapter device is constructed to connect to the CTS application of the electronic device via WiFi connection,
wherein the first and second WiFi transceivers are configured to share a same network,
wherein the third and fourth WiFi transceivers are configured to share a same network, and
wherein the first and third WiFi transceivers are configured not to share a same network.

17. The system of claim 16, wherein the first adapter device includes a codec to convert analog signals from the RJ-9 port or the 3.5 mm audio jack to digital signals and covert digital signals to analog signals for being sent to the RJ-9 port or the 3.5 mm audio jack.

18. The system of claim 16, wherein the telephone provides robust call control capabilities, and the second Bluetooth transceiver and the CTS application are configured to support the robust call control capabilities.

19. The system of claim 18, wherein the robust call control capabilities include a one-button call control.

20. The system of claim 16, wherein the system is configured to provide in-call audio streaming.
